(19) United States
(12) Patent Application Publication
(10) Pub. No.: US 2001/0005203 A1
(43) Pub. Date: Jun. 28, 2001

(54) METHOD FOR GENERATING MULTIMEDIA PRESENTATION

(76) Inventor: ADY WIERNIK, TEL AVIV (IL)

Correspondence Address: Paul J. Sutton, Esquire, Met Life Building, 885 THIRD AVE., NEW YORK, NY, 10022, US

(21) Appl. No.: 08/981,698

(22) PCT Filed: Jul. 2, 1996
(86) PCT No.: PCT/IL96/00032

§ 371 Date: None

(30) Foreign Application Priority Data
Jul. 3, 1995 (IL) 114432

(51) Int. Cl. G06F 15/00

(52) U.S. Cl. 345/302

(57) ABSTRACT

A method for generating a derived multimedia application from a master multimedia application, wherein the master application uses a data base and two or more screens (4, 6, 8) defined as entries in the database, the method including the steps of sorting the screens in a predetermined order, utilizing at least one selection criterion (12a, 12b, 12c) to create a derived multimedia application consisting of one selection including at least one of the screens which conform to the selection criterion, and providing means so that the derived multimedia application acts like a stand-alone multimedia application.

### FIELD OF THE INVENTION

The present invention relates to a novel method for generating a multi-media application.

### BACKGROUND OF THE INVENTION

Multi-media methods for generating multi-media applications are based on items called screens, each screen corresponding to a screen displayed to the user. Each screen includes information which may be presented in a multi-media by visual means, still or moving images, sound means, touch means and the like. The screens are edited using a multi-media generator, which in general includes abilities like editing media files (sound, animation, images, robotics commands and the like), allocating new screens and defining their properties, defining the links which determine the flow from one screen to the next, and the like.

A multi-media application as known in the art is defined in terms of predetermined screens and a structure of predetermined links.

Multi-media generating methods divide into three groups.

A first group includes multi-media methods, which for example, are commonly used for generating presentations. Multi-media generators according to these methods, use simple link models in which the screens are also called “slides”. In these models, each slide includes a link, pointing to the next slide. Links may point to other preceding or following slides. The main disadvantage of these methods is that structure of flow is rigid.

A second group includes multi-media methods, which include “hot-buttons”. These hot-buttons, also called “hot links”, are used to activate action sequences for determining the next screen according to parameters such as variables, formulas, previous user data entry values and the like.

The structure of the flow in multi-media applications according to the second group is more dynamic compared with the first group. However, a developer using a multi-media tool according to the second group, has to consider and take into account every possible path through the application. Inserting a screen into such a multi-media application which includes direct links, requires updating of all the relevant links to point to the added screen.

A third group includes data-bases which include some multi-media support. Such data-bases include multi-media fields which contain multi-media information which for example may be an image. These systems are dynamic as far as the data in considered. However, the flow structure, is rigid and so is the interactivity.

According to the present art, each screen includes a template, which is used to locate the various data on screen. These templates are predetermined in a rigid manner, in which they are referred to as a layout for placing data. According to the known art, a template can not be modified locally.

Some multi-media generators, enable attaching actions to objects which may be used in predetermined parts of an application. This approach has some effect in small scale application, but not for large scale application, which may include more than 20,000 screens like, for example, a computerized encyclopedia. Such large scale applications include screens which are mostly similar, but have many local or regional modifications.

Modern programming languages support notions of “classes” and “inheritance”. Classes include both data structures and program portions. Using the notions of classes and inheritance, the basic definition of a class (e.g. a base class) is modified to create derived classes. The modification can include operations such as:

Use class elements defined in the base class.

Modify class elements which are defined in the base class.

Unite elements from a number of classes (multiple inheritance).

Add new elements to the class.

However, these operations are applied to language constructs in programming languages but, are not known in the art of multi-media.

### SUMMARY OF THE INVENTION

It is an object of the present invention to provide a method for generating dynamic multi-media applications, which is both simple for the developer and which overcomes disadvantages of prior art.

Another object of the present invention is to provide a method for generating new screen designs for a multi-media application, based on previous screen designs which are included in the multi-media application.

There is thus provided in accordance with the present invention a method for generating a derived multi-media application from a master multi-media application, wherein the master application uses a data base and two or more screens defined as entries in the database, the method including the steps of sorting the screens in a predetermined order, utilizing at least one selection criterion to create a derived multimedia application consisting of one selection including at least one of the screens which conform to the selection criterion, and providing means so that the derived multimedia application acts like a stand-alone multimedia application.

A further object of the present invention is to facilitate the process of creating additional multi-media screens, by providing a method for creating new screens by using a process of inheritance, in which such new screens are generated inheriting some characteristics from already existing screens, or combinations thereof.

Accordingly, the present invention also provides a method for generating a new multi-media screen from at least one existing multi-media screen, each of the screens including at least one multi-media item, each item having a plurality of attributes, the method including the steps of selecting at least one of the existing multi-media screens as a template for the new screen, modifying the template to create the new screen, and saving the new screen as a new existing multi-media screen.

### BRIEF DESCRIPTION OF THE DRAWINGS

The present invention will be further understood and appreciated from the following detailed description taken in conjunction with the drawings in which:

FIG. 1 is an illustration of a screens and various links of a multi-media application constructed in accordance with a first embodiment of the present invention;

FIG. 2a is a block diagram of a stack according to another embodiment of the invention;

FIG. 2b is a block diagram of a different state of the stack of FIG. 2a;

FIG. 3a is an illustration of an inheritance process according to a further embodiment of the present invention; and

FIG. 3b is an illustration of a different state of the inheritance process of FIG. 3a.

### DETAILED DESCRIPTION OF THE INVENTION

The present invention relates to a novel method of generating a multi-media application. As will be appreciated from the following description, the method of the invention is characterized by ease of use and a highly dynamic flow structure.

According to the above method, a multi-media application may be defined as a dynamic entry. According to the method of the invention there may be at least two types of links from one multi-media screen to another.

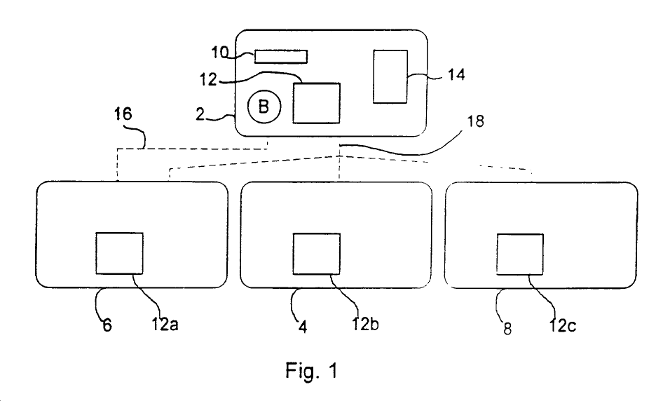

The first type of links includes explicit links. An explicit link is a predetermined command to go from a first predetermined screen to a second one when a certain event occurs. In FIG. 1 there is shown a set of screens 2,4,6 and 8. Screen 2 includes a button marked “B”. Pressing button “B”, executes explicit link 16 directly to screen 6.

The second type of links includes data-driven links. In FIG. 1, link 18 is a data driven link, which links screen 2 to any sub-set of screens selected from the set which contains screens 4, 6 and 8. The decision is a selection criteria which is based on various pieces of data found in screens 4, 6 and 8, which in the present example, is data stored in fields 12a, 12b and 12c. One of the advantages of this is that when screens are later added to the application, they may also be automatically added to the selection in run time, if they correspond to the selection criteria, wherein in the known art, the developing user has to manually predetermine the links between the multi-media application and the newly added screens.

In multi-media systems which are connected to external data-bases which include multi-media records (for example a multi-media news data-base which is updated constantly), data driven links according to the invention provide the user an automatically updated link structure.

According to the method of the present invention, each screen is stored as a record or entry in a data base. This data base may be either internal or external. Each of the screens may include a predetermined definition of a layout, which is also called a template. A template may be used to predeterminaly define the layout of several screens, and thus may be stored as an individual record in the same data base which contains these screens or in a separate data base.

According to the invention, a number of screens may be selected into a group also called a sub-set. The selection process may includes queries which are a series of Boolean expressions, referring to various types of data which is stored in each of the screens. For example, search for screens which includes the text “dog” and a sound of a train or a picture of a frog.

The result of such a query is a sub-set of the data base, of a predetermined given part of the data base or of a predetermined multi-media application. According to the invention, a sub-set is also referred to as a “selection”.

It will be appreciated that a query may be activated manually (by the user) or by a hot-spot button in the application. In addition, an execution of a query may be stopped automatically or manually before it completes scanning all of the screens, for example, when the preliminary results are sufficient. As screens are added to the application, a sub-set which included results for a predetermined query may no longer be updated. In such a case, if this query is re-executed, the group of screens which is included in the sub-set may be different than the one which was generated in the previous run. This represents a new type of link which is highly dynamic.

According to the invention, the flow structure uses a “goto” and a “gosub and return” model, which utilizes a stack mechanism, wherein different types of elements are added gradually to this stack by the main algorithm of the invention. This structure is highly dynamic, easy to learn and operate and as a result, shortens the development time period.

A stack according to the invention may include screens or selection of screens, along with pointers to origin screens (in each stack element) which are needed for “return” commands.

It will be appreciated by those skilled in the art that structure types such as a list, a queue, a tree and the like, may be adapted to simulate a stack, and as such, they may be applicable for the present invention.

It is a particular feature of the present invention that the selection-based derived multimedia application acts like a stand-alone multimedia application. This is accomplished by providing means, such as traversal buttons (previous, next), and the possibility of using queries based on the current selection, etc., when working with the derived application.

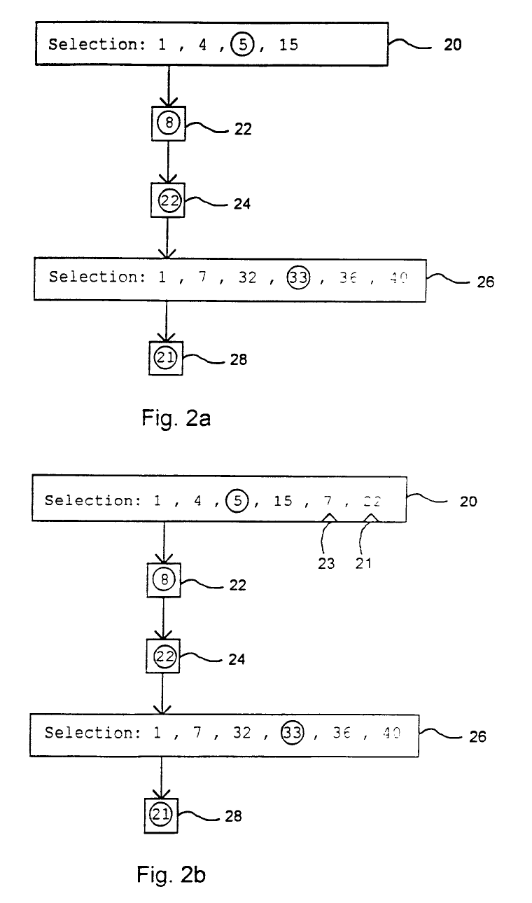

FIG. 2a is a block diagram of a stack according to another embodiment of the invention. The stack according to the invention may include two types of entries. A first type, numerals 22, 24 and 28, is called a “single item element”. These elements include a pointer to a single predetermined screen. In FIG. 2a, single item element 22 includes a pointer to screen no. 8, single item element 24 includes a pointer to screen no. 22 and single item element 28 includes a pointer to screen no. 21. A second type, numerals 20 and 26, is called a “selection element”. A selection element may include one or more pointers to predetermined screens, as well as an indication of the current item in the selection. In FIG. 2, selection item 20 includes a selection of screens no. 1, 4, 5 and 15 wherein screen no. 5 is indicated as the current item. Selection item 26 includes a selection of screens no. 1, 7, 32, 33, 36 and 40 wherein screen no. 33 is indicated as the current item.

The stack also includes information relating to the last element that was added into the stack and the last selection element that was added to the stack. In this case, although the last selection may not be the last element, it is always available.

In an application according to the invention, the screens are arranged in a predetermined order. This is essential for commands such as “goto next screen” and “goto previous screen” and the like.

A selection element, according to the invention, may be stored as a predetermined group of screen items or as a virtual selection. A virtual selection includes three types of information. A first type is the base selection which may be the entire application, the last selection or any other selection. A second type is a definition of a selecting criterion, for example a query. A third type includes a sub-set of elements which were already found and elaborated by the virtual selection, from the base selection, according to the selecting criteria.

Virtual selections are needed when the user would just like to browse a few elements in the selection but not to actually view all elements in the selection. Thus, there is no need to predetermine all screens in the selection, i.e. to fully elaborate it.

When a selection is first created, all its screens are called “original screens”. A selection can also contain “New screens”. These new screens are screens to which screens in selection branched using a “goto” command. These screens are added to the selection, but are marked as new accordingly (i.e. new screens), so they can be differentiated from the original screens of the selection.

In the present example, screen 4 in selection item 26, shown in FIG. 2b, includes a goto link to screen 7. In this case, this screen may be added to the selection either automatically, or manually by the user, as is shown in FIG. 2b. Screen 7 is then marked (numeral 23) as a screen which was not added to the selection by the query. Screen 7 includes a link to screen 22. Screen 22 is then added to the selection and marked accordingly. Screen 22 includes a link to screen 44 (not shown) which in the present example is not added, at the user's decision.

The method according to the invention has several advantages among which are:

A first advantage is flexibility. The method provides the user with the ability to create a generic multi-media application wherein the “behavior” of this application may change from run to run. According to the present invention the behavior of a predetermined application run may be made to depend on the outcome of the previous run, or on the data stored in the application, or on the data given by the user and used as parameter to selection queries.

For example, in an application which represents a virtual shopping mall which includes screens relating to shops and goods for sale, a query for goods listed for a low price will generate a new application for a “cheap mall”, a query for goods which include an indication of a discount will generate a new application for a “cost-effective mall” and a query for textile, red or blue colored items for men will generate an application of users' taste of men's clothing.

A second advantage is the ease of maintenance. New screens may be added and removed, to and from an application. According to the invention, when adding a new screen to a multi-media application, the information which is included in this screen (i.e., key words, text, field values and the like) is used by the queries to locate this screen and add it to the flow structure of the multi-media application or to a sub-set application.

A third advantage is that the flow may be made to be content sensitive. The developing user can define a selection application wherein the query relates to a given property or a predetermined value of a field and the like. This is a semi-automatically-created sub-set application. In this case, the developing user does not have to consider in advance all possible elements in a predetermined given screen since the automatic application does it for him.

The method of the invention also employs the concept of inheritance (commonly used to define data structures, such as classes, in object oriented programming languages) for the definition of screens, user interface element and actions in a multi-media generator. This is done while preserving the basic uniformity between screens, which allows queries (for example) to be used on fields in each screen record. The screens, or screen elements, can be modified locally in any required manner. Screens can be used a templates for other screens, as required, and hierarchical structures can be created by the user.

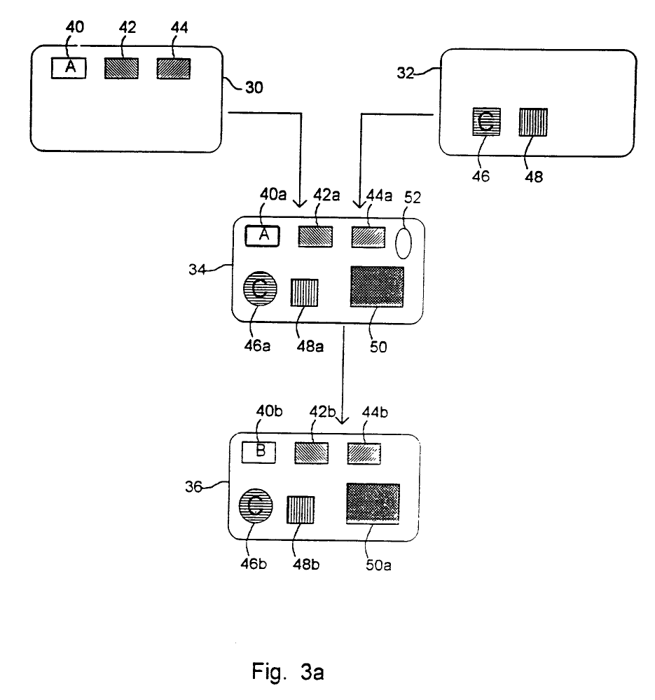

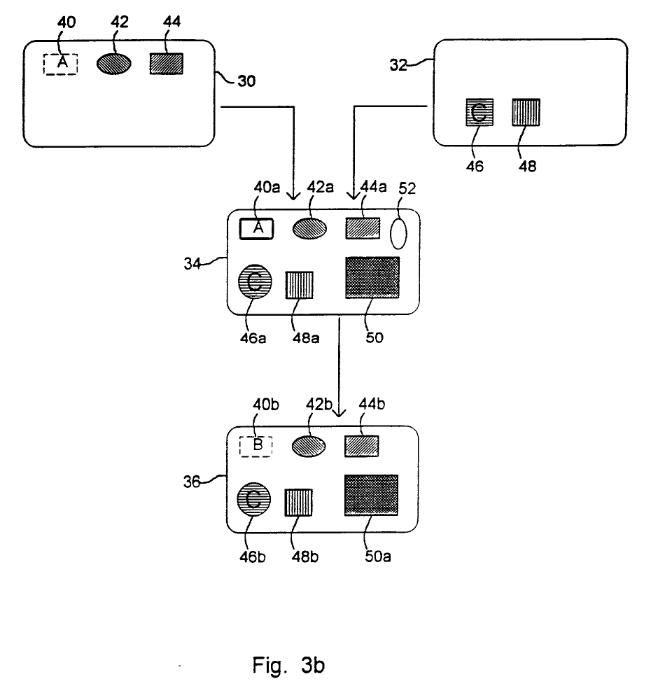

FIG. 3a is an illustration of an inheritance process according to the present invention. A screen 30, includes multi-media items 40, 42 and 44. A screen 32 includes multi-media items 46 and 48. Screen 34 inherits from screens 30 and 32 and thus includes multi-media items 40a, 42a, 44a, 46a and 48a. The situation shown in the present example, where a screen inherits from two or more parent screens is called “multiple inheritance”. Screen 34 is then modified so as to included multi-media items 50 and 52. In the present example, multi-media item 52 is defined as a local modification, and as such may not be inherited by “offspring” screens, such as screen 36. Screen 36 inherits from screen 34 and thus includes multi-media items 40b, 42b, 44b, 46b, 48b and 50a. Screen 36 is then modified locally by adding to it multi-media item 52. In the present example screen 30 and 32 are the parent screens to screen 34 which is the parent screen of screen 36.

An inheritance process according to the invention may be executed when creating a new screen, editing a screen or when a screen is loaded for viewing. Each screen element (sound, animation, images, robotics commands and the like) is predetermined in terms of data field attributes, including, but not limited to, location and size, font in use, language, description, value, a list or table of allowable values, title and the like.

Attributes may be simple or complex. A simple attribute includes a single value, for example, a color of a field. Multi-media item 40a is a field inherited according to multi-media item 40. The frame of field 40a is modified to include curved corners and a thickened line style. This modification is defined locally and as such is not inherited by multi-media item 40b, but does not affect the parent screens 30 and 32. A complex attribute may include two or more simple or complex attributes. An example of a complex attribute is a field title which includes attributes such as title font, title text color, title background color, title location and the like. It will be appreciated that according to the invention, each field is a complex attribute.

Each of the screens may be an inheriting screen, providing it is not the first one. The user predetermines the “parent” screen or screens which are to be used as templates for a new “son” screen. Then, the user may add modifications in the “son” screen. These modifications may consist of adding new attributes, making changes in attribute values and deleting attributes. Modifications can be marked as local or global modifications, which determines whether or not they are to be inherited by later screens.

The user may also delete inherited attributes, such as an entire field, or modify an attribute which for example may be setting a value for a given field.

Inheriting screens may be stored as sets of modifications to their parent screens. The modification data stored may consist of pointers to the “parent” template screen or screens, and the various modifications which are adding, deleting and changing attributes.

The fact that visual modifications are each separate from the substantial content of a field enables the preservation of query uniformity. This means that a query may ignore the visual properties of a field which may be modified differently in some screens, and still refer to their substantive value. Thus, a query for the value “A” for field No. 40# will result in a selection which includes screens 30 and 34.

According to the inheritance process of the invention, if an attribute of an item in a screen is re-modified in a non-local way, all of “offspring” screens of this screen will inherit this modification. Such a non-local modification may be either a global modification or a regional modification, which may be inherited by “offspring” screens according to a predetermined criteria. In FIG. 3b, the shape attribute of multi-media item 42 is re-modified to be oval instead of rectangular. This property is then inherited, in the modification of item 42a, by screen 34. Since screen 36 inherits from screen 34, the newly inherited re-modified item 42a is inherited, in item 42b, by screen 36.

In the present example, the frame line style of item 40 is re-modified to include a broken line style. This property is passed on to be inherited by screen 34. Since the frame line style of item 40a has been modified locally, screen 34 does not inherit this property from screen 30. The broken line style property is then passed on to be inherited, in item 40b, by screen 36.

It will be appreciated by those skilled in the art that the invention is not limited to what has been shown and described herein above by way of example. Rather, the scope of the invention is limited solely by the claims which follow.

1. A method for generating a derived multimedia application from a master multimedia application, wherein the master application uses a data base and two or more screens defined as entries in the database, the method comprising the steps of:
(a) sorting said screens in a predetermined order;
(b) utilizing at least one selection criterion to create a derived multimedia application consisting of one selection including at least one of said screens which conform to said at least one selection criterion; and
(c) providing means so that the derived multimedia application acts like a stand-alone multimedia application.

2. The method as claimed in claim 1, wherein said step of utilizing includes utilizing at least two selection criteria, and further comprising the step of filling a stack with selections resulting from said selection criteria.

3. The method as claimed in claim 1, further comprising expanding said selection by means of at least one explicit link.

4. The method as claimed in claim 1, further comprising branching from within the derived application to other areas of the master application and returning to said derived application using said stack.

5. The method as claimed in claim 4, wherein said stack includes both single elements and entire selections.

6. In a multimedia application, including a plurality of existing multimedia screens, each said existing multimedia screen including at least one multimedia item, each said multimedia item having plurality of attributes, a method for generating a new derived multimedia screen, the method comprising the steps of:
(a) selecting a group including at least one parent multimedia screen from said existing multimedia screens as a template for the new multimedia screen;
(b) modifying said template thereby creating the new derived multimedia screen; and
(c) saving said new derived multimedia screen as a set of modifications applied to said template.

7. The method as claimed in claim 6, wherein said group includes at least two parent multimedia screens, further comprising the step of:
merging said group of parent multimedia screens to provide said template for said new derived multimedia screen, before said step of modifying.

8. The method as claimed in claim 6, further comprising the steps of:
modifying at least one of said selected parent multimedia screens, thereby determining at least one parent modification; and
automatically modifying said new derived multi-media screen according to said parent modification.

9. The method as claimed in claim 6, wherein said step of modifying includes a step selected from the group consisting of adding a new attribute to a multimedia item, deleting a previously defined attribute from a multimedia item, and changing an attribute of a multimedia item.

10. The method as claimed in claim 6, wherein said step of modifying includes providing a local modification.

11. The method as claimed in claim 6, wherein said step of modifying includes providing a regional modification.

12. The method as claimed in claim 6, wherein said step of modifying includes providing a global modification.

13. The method according to claim 1 wherein said database is linked to an external database.

14. The method according to claim 1 wherein each said screen is linked to at least one of said screens, via a dynamic link.

15. The method according to claim 14 wherein said dynamic link is determined according to a selection criterion.

16. The method according to claim 15, wherein said selection criterion is defined by an end user during run time.
